(19) United States
(12) Patent Application Publication
(10) Pub. No.: US 2008/0070084 A1
(43) Pub. Date: Mar. 20, 2008

(54) Fuel electrode precursor of low shrinkage rate in an electric power generation cell for a solid oxide fuel cell

(76) Inventors: Tatsumi Ishihara, Fukuoka (JP); Takashi Yamada, Ibaraki (JP)

Correspondence Address: WENDEROTH, LIND & PONACK, L.L.P., 2033 K STREET N. W., SUITE 800, WASHINGTON, DC, 20006-1021, US

(21) Appl. No.: 11/522,937

(22) Filed: Sep. 19, 2006

(51) Int. Cl. H01M 8/10; B05D 1/00; C22C 32/00

(52) U.S. Cl. 429/33; 419/20; 427/372.2; 429/30

(57) ABSTRACT

A fuel electrode precursor of low shrinkage rate in an electric power generation cell for a solid oxide fuel cell is provided, wherein: the fuel electrode precursor is made of a sintered body prepared from a green body constituted with oxide ceramic grains composed of at least one of yttria-stabilized zirconia, scandia-stabilized zirconia, samarium-doped ceria and gadolinium-doped ceria and metal oxide grains composed of at least one of nickel oxide, copper oxide and ruthenium oxide; and the fuel electrode precursor at least has a structure in which an iron-containing oxide is present in a grain boundary surrounding the metal oxide grains.

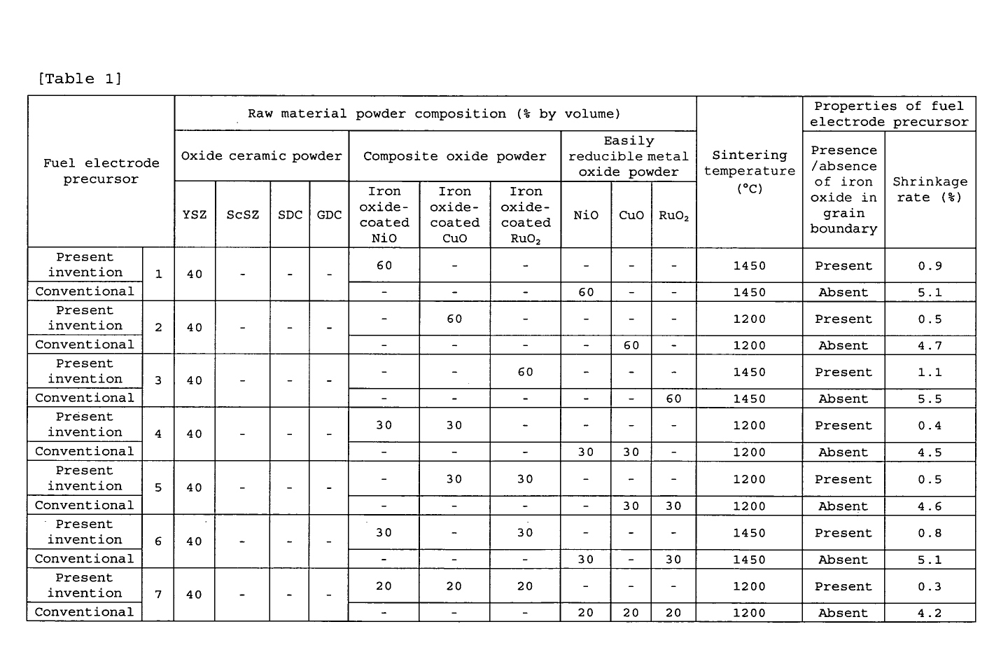

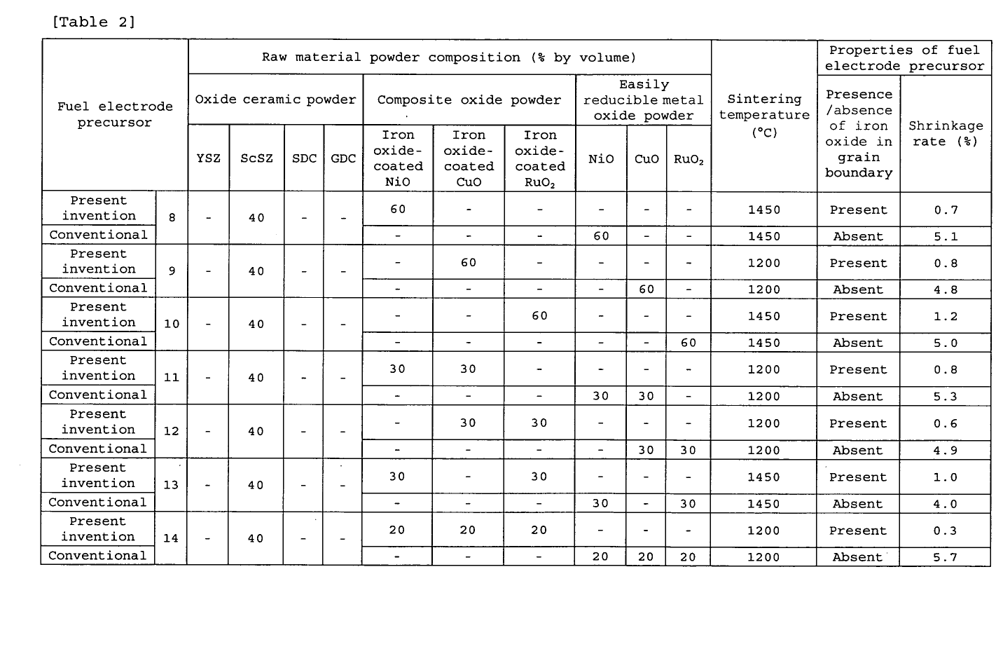

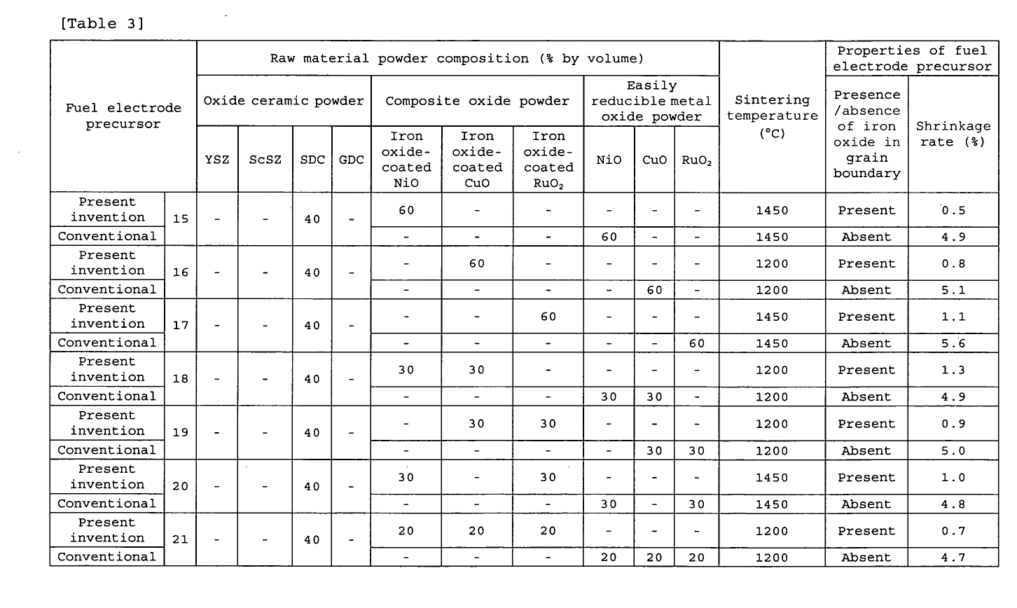

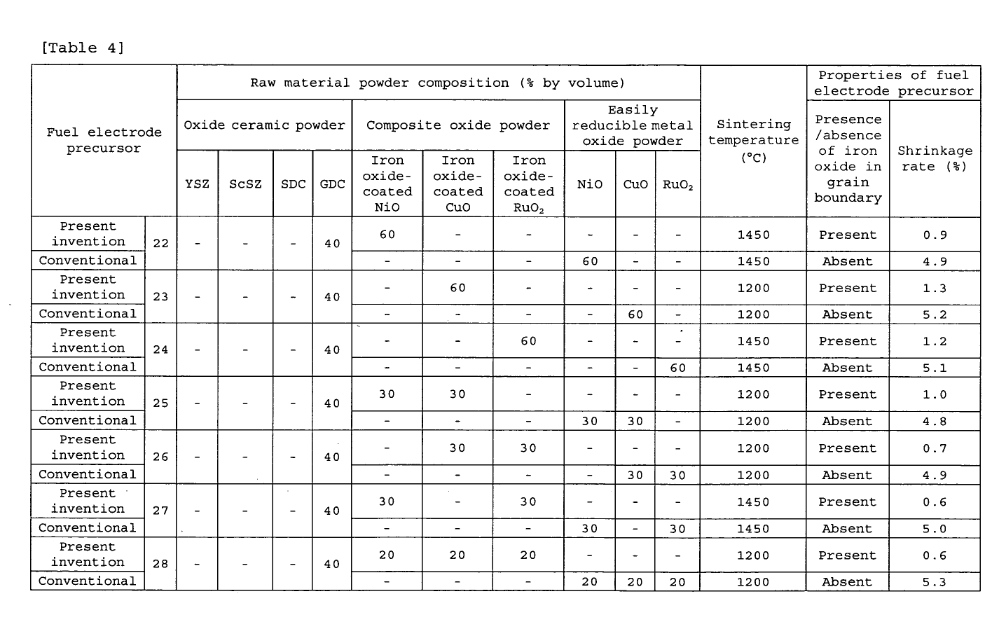

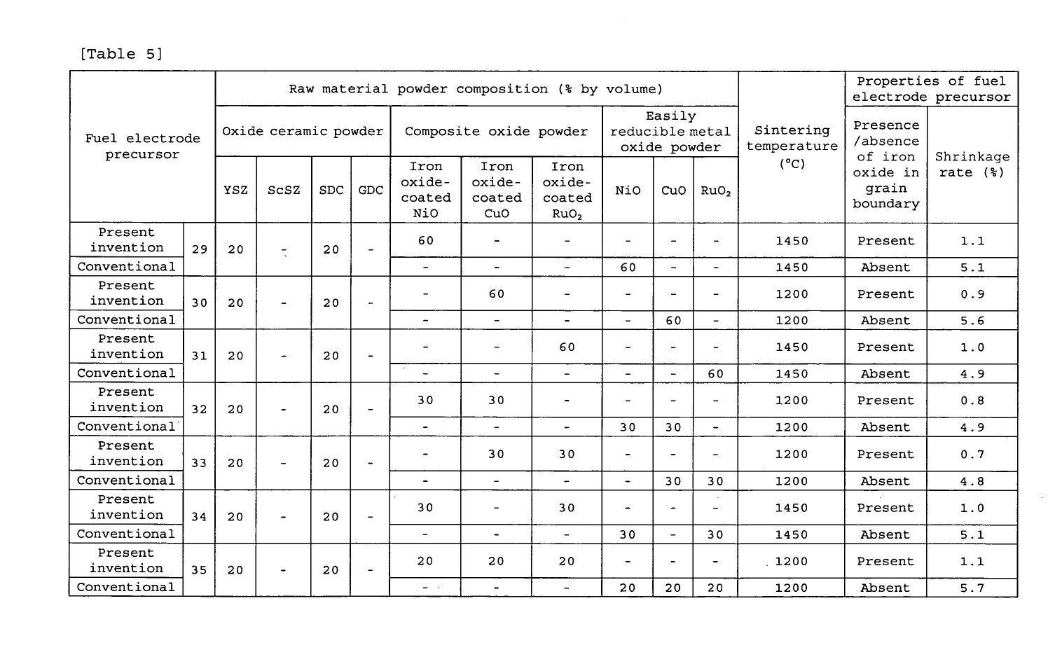

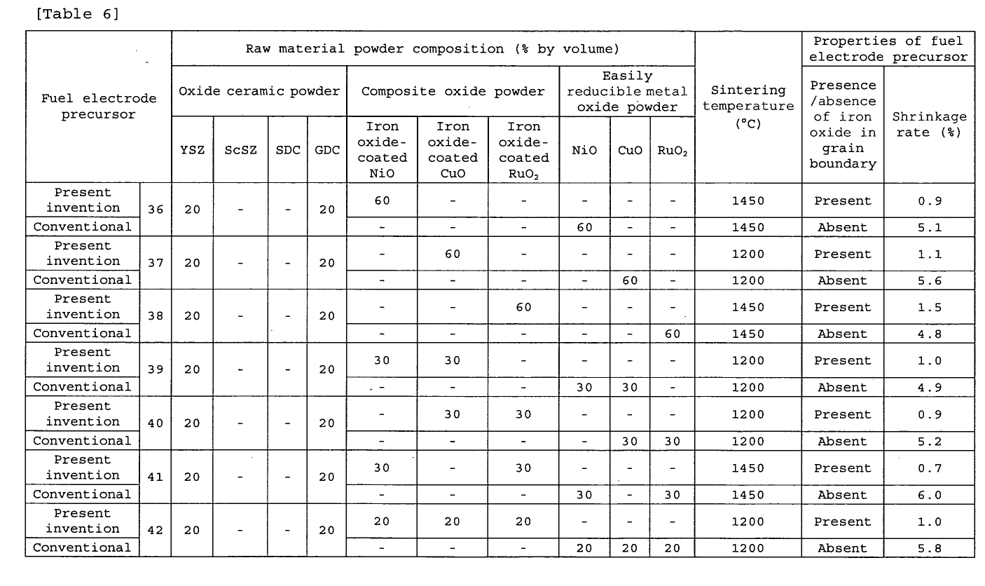

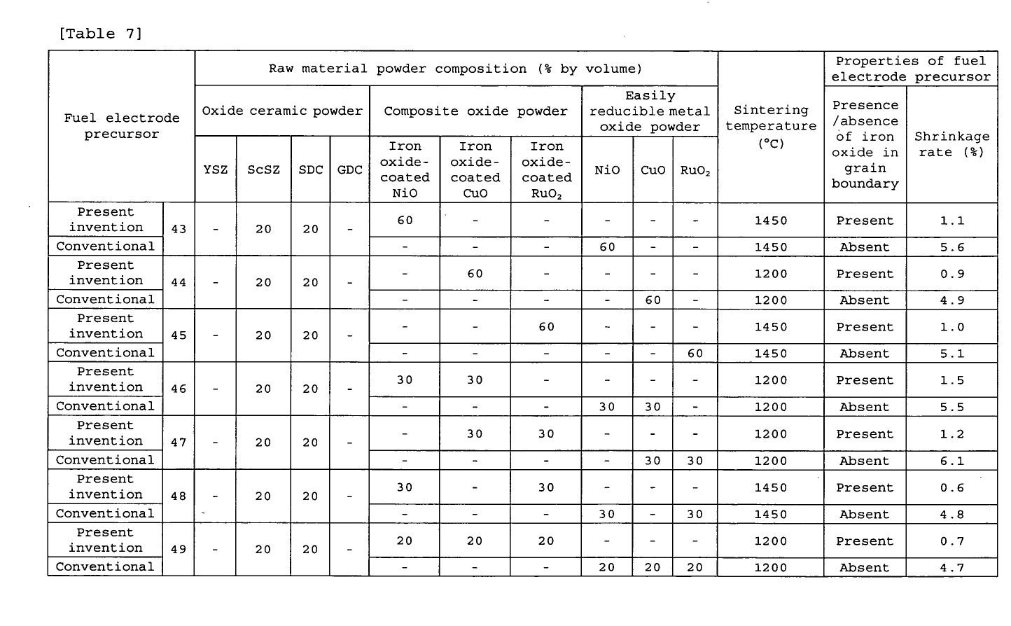

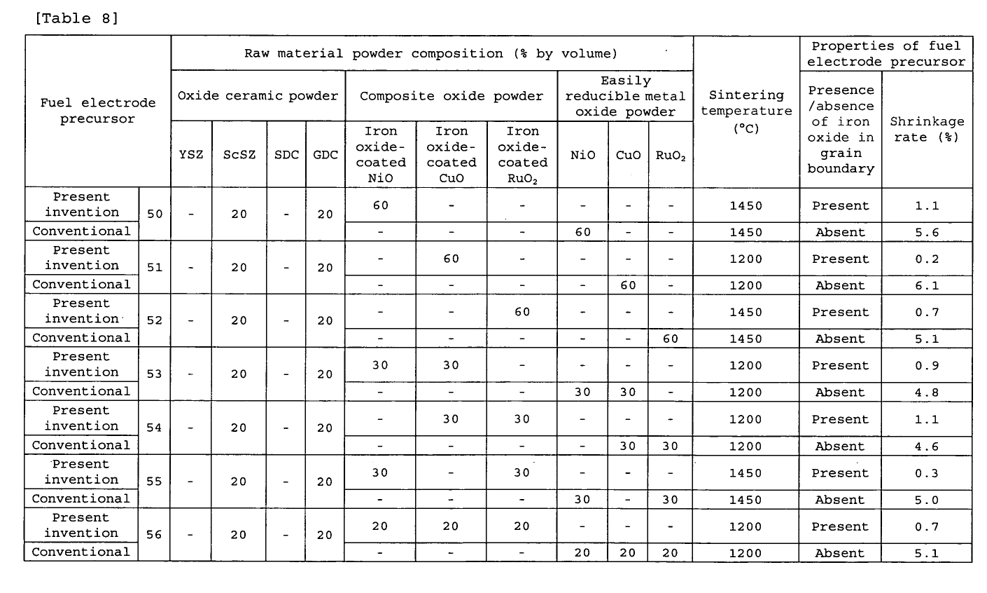

### BACKGROUND OF THE INVENTION

1. Field of the Invention

The present invention relates to a fuel electrode precursor of low shrinkage rate in an electric power generation cell for a solid oxide fuel cell.

2. Description of the Related Art

In general, a solid oxide fuel cell can use, as fuel, hydrogen gas, natural gas, methanol, coal gas and the like, and hence can promote the replacement of petroleum with alternate energy sources in electric power generation. Further, waste heat from the solid oxide fuel cell can be used, and the solid oxide fuel cell is thereby attracting attention from the view points of resource saving and environmental issues. In general, such a solid oxide fuel cell has a structure in which: an electric power generation cell has a structure composed of an air electrode laminated on one side of a solid electrolyte member made of one or more oxides and a fuel electrode laminated on the other side of the solid electrolyte member; an air electrode current collector is laminated on the outside of the air electrode of the electric power generation cell and a fuel electrode current collector is laminated on the outside of the fuel electrode of the electric power generation cell; and a separator is laminated on the outside of the air electrode and another separator is laminated on the outside of the fuel electrode.

The fuel electrode precursor constituting the electric power generation cell of the solid oxide fuel cell is obtained by sintering a mixture prepared by mixing together at least one of oxide powers such as a NiO powder, a CuO powder and a RuO₂ powder and at least one of oxide ceramic powders such as yttria-stabilized zirconia (hereinafter referred to as YSZ), scandia-stabilized zirconia (herein after referred to as ScSZ), samarium-doped ceria (hereinafter referred to as SDC) and gadolinium-doped ceria (hereinafter referred to as GDC). Accordingly, the fuel electrode precursor has a mixed structure composed of the grains of at least one of the oxides such as NiO, CuO and RuO₂ and the grains of at least one of the oxide ceramics such as YSZ, ScSZ, SDC and GDC.

The NiO, CuO and RuO₂ contained in the fuel electrode precursor are reduced into Ni, Cu and Ru, respectively, through the reduction of the fuel electrode precursor containing NiO, CuO and RuO₂, occurring during the operation of the solid oxide fuel cell, although they are reduced into Ni, Cu and Ru, respectively, in a positive manner as the case may be (see Japanese Patent Laid-Open Nos. 2006-40612, 10-3930 and 4-190562).

The fuel electrode precursor is required to be porous, and accordingly, fabricated in such a manner that the raw material powder is added with a pore forming agent, the firing temperature is made lower or the firing time is made shorter to avoid densification thorough firing (see Japanese Patent Laid-Open No. 63-102168).

The electric power generation cell for a solid oxide fuel cell is broadly classified into a self-supported membrane electric power generation cell and a fuel electrode-supported electric power generation cell. The self-supported membrane electric power generation cell is fabricated by laminating a fuel electrode membrane and an air electrode membrane on an electrolyte membrane having a mechanical strength, and hence has a sufficient mechanical strength. On the other hand, a fuel electrode-supported electric power generation cell has a structure in which a thin electrolyte membrane is formed on a surface of a thick fuel electrode precursor having a high mechanical strength, and a thin air electrode membrane is further formed on the thin electrolyte membrane, thus the mechanical strength being attained by the thick fuel electrode precursor having a high mechanical strength and the fuel electrode after having been reduced. Accordingly, as is said to be preferable for the purpose of improving the fuel cell performances, in the fuel electrode-supported electric power generation cell, the fuel electrode attains the mechanical strength of the electric power generation cell, and hence the electrolyte membrane can be made thin; the thus actualized thin electrolyte membrane reduces the internal resistance of the fuel cell, consequently enabling low temperature operation.

A fuel electrode-supported cell is fabricated, for example, by a method in which powders of the metal oxides such as NiO, CuO and RuO₂ are mixed with oxide ceramic powders such as YSZ, ScSZ, SDC and GDC, and the mixed powder is compacted into a thick plate; this thick plate is bonded to a thin plate obtained by compacting an electrolyte powder; and then the bonded product is fired to yield a fuel electrode-supported cell (see Japanese Patent Laid-Open No. 2000-48831). However, a fuel electrode-supported cell is usually fabricated by a method in which powders of the metal oxides such as NiO, CuO and RuO₂ are mixed with oxide ceramic powders such as YSZ, ScSZ, SDC and GDC, and the mixed powder is compacted into a thick plate; the surface of this thick plate is coated with an electrolyte powder; and the thus coated plate is fired to yield a fuel electrode-supported cell (see Japanese Patent Laid-Open No. 2003-346864). As the method for forming a thin electrolyte membrane, a physical vapor deposition method and a chemical vapor deposition method are available; there has also been reported a research on the formation of electrolyte membranes by using these methods (see Japanese Patent Laid-Open No. 11-229142).

### SUMMARY OF THE INVENTION

The electric power generation cell for a solid oxide fuel cell has a structure in which an electrolyte membrane is formed on the surface of a fuel electrode precursor made of a porous material having a mixed structure composed of the grains of at least one of the metal oxides such as NiO, CuO and RuO₂ and the grains of at least one of the oxide ceramics such as YSZ, ScSZ, SDC and GDC; the electrolyte membrane is required to be a dense membrane uniform in thickness because when the electrolyte membrane has through-holes therein, oxygen flowing on one surface of the electrolyte membrane and a fuel flowing on the other surface of the electrolyte membrane unpreferably mix together to result in a combustion reaction.

The metal oxides such as NiO, CuO and RuO₂ constituting the fuel electrode precursor are reduced to Ni, Cu and Ru, respectively, during the operation of the solid oxide fuel cell, and consequently, the fuel electrode precursor is shrunk; the thus shrunken fuel electrode precursor induces the shrinkage of the dense electrolyte layer formed on the surface of the fuel electrode precursor; the strain caused by the shrinkage comes to stay in the interior of the electrolyte membrane; thus, in many cases, the electrolyte membrane undergoes cracking to result in a state equivalent to a state that through-holes are generated in the electrolyte membrane; and consequently, the electric power generation efficiency is degraded. Alternatively, even if cracking does not occur, the shrinkage of the fuel electrode precursor induces the internal stress in the electrolyte membrane or the nonuniformity of the thickness of the electrolyte membrane; consequently, the electric resistance value along the thickness direction becomes nonuniform because such electric resistance is proportional to the membrane thickness; thus, during the use of the solid oxide fuel cell, the electric current density becomes nonuniform along the surface of the electrolyte membrane to result in an unsatisfactory electric power generation performance.

In particular, in a fuel electrode-supported electric power generation cell in which a thin electrolyte membrane is formed on the surface of a thick fuel electrode precursor, a thin air electrode membrane is formed on the thin electrolyte membrane, and thus the mechanical strength of the electric power generation cell is attained by the thick fuel electrode precursor or the fuel electrode after reduction, the shrinkage of the thick fuel electrode precursor significantly affects the cracking and the membrane thickness nonuniformalization of the thin electrolyte membrane and the thin air electrode membrane, and significantly degrades the electric power generation capacity of the solid oxide fuel cell.

Under these circumstances, the present inventors have fabricated a fuel electrode precursor low in shrinkage when the fuel electrode precursor undergoing reductive action, on the basis of the estimation that the cracking or the thickness nonuniformalization of the electrolyte membrane is caused by the shrinkage of the fuel electrode precursor; the present inventors have recognized that the electric power generation cell obtained by forming an electrolyte membrane on the fuel electrode precursor low in shrinkage even when reduced scarcely undergoes the generation of the cracking or the thickness nonuniformalization of the electrolyte membrane because of the low shrinkage of the fuel electrode precursor during the operation of the solid oxide fuel cell, and hence scarcely leads to the degradation of the electric power generation capacity of the solid oxide fuel cell; on the basis of this recognition, the present inventors have developed a research that aims to obtain a fuel electrode precursor that undergoes low shrinkage even when the metal oxides such as NiO, CuO and RuO₂ are reduced into Ni, Cu and Ru, respectively.

Consequently, there have been obtained research results that include the following results.

(a) A mixed powder is prepared by mixing a composite metal oxide powder which is prepared by forming an iron-containing oxide film on the surface of a powder of a metal oxide (hereinafter referred to as easily reducible metal oxide) composed of at least one of NiO, CuO and RuO₂ with a powder of an oxide ceramic (hereinafter referred to as oxide ceramic) composed of at least one of YSZ, ScSZ, SDC and GDC; a fuel electrode precursor that is made of a sintered body obtained by sintering the mixed powder has a structure in which an iron-containing oxide is present in the grain boundary surrounding the easily reducible metal oxide grains; and the fuel electrode precursor that has the structure in which an iron-containing oxide is present in the grain boundary surrounding the easily reducible metal oxide grains is scarcely shrunk even when heated in a reductive atmosphere.

(b) The sintered body, obtained by sintering the mixed powder obtained by mixing the composite metal oxide powder which is prepared by forming an iron-containing oxide film on the surface of the easily reducible metal oxide powder with the oxide ceramic powder, is further preferably 93% or more in density; the sintered body of 93% or more in density is obtained by sintering a mixed powder wherein the mixed powder is prepared by mixing the composite metal oxide powder prepared by forming an iron-containing oxide film on the surface of the easily reducible metal oxide powder with the oxide ceramic powder within a volume ratio of 4/1 to 2/3, preferably 7/3 to 1.

(c) The iron-containing oxide present in the grain boundary surrounding the easily reducible metal oxide grains is preferably any one of FeO, Fe₂O₃, Fe₃O₄, and a composite oxide between the easily reducible metal oxide(s) and Fe, and the iron-containing oxide is further preferably formed in a film-like form to surround the whole surface of the easily reducible metal oxide grains.

The present invention has been achieved on the basis of the above-mentioned research results, and is characterized by the following aspects (1) to (5) and the like.

(1) A fuel electrode precursor of low shrinkage rate in an electric power generation cell for a solid oxide fuel cell, wherein: the fuel electrode precursor is made of a sintered body prepared from a green body constituted with grains of an oxide ceramic (hereinafter referred to as oxide ceramic) composed of at least one of yttria-stabilized zirconia, scandia-stabilized zirconia, samarium-doped ceria and gadolinium-doped ceria and grains of a metal oxide (hereinafter referred to as easily reducible metal oxide) composed of at least one of nickel oxide, copper oxide and ruthenium oxide; and the fuel electrode precursor at least has a structure in which an iron-containing oxide is present in a grain boundary surrounding the easily reducible metal oxide grains.

(2) A fuel electrode precursor of low shrinkage rate in an electric power generation cell for a solid oxide fuel cell, wherein: the fuel electrode precursor is made of a dense sintered body of 93% or more in density prepared from a green body constituted with oxide ceramic grains and easily reducible metal oxide grains; and the fuel electrode precursor at least has a structure in which an iron-containing oxide is present in the grain boundary surrounding the easily reducible metal oxide grains.

(3) The fuel electrode precursor of low shrinkage rate in an electric power generation cell for a solid oxide fuel cell, according to the above-mentioned (2), wherein the fuel electrode precursor made of the dense sintered body of 93% or more in density has a structure in which the easily reducible metal oxide grains and the oxide ceramic grains are dispersed in a volume ratio of 4/1 to 2/3 in the green body thereof.

(4) The fuel electrode precursor of low shrinkage rate in an electric power generation cell for a solid oxide fuel cell, according to the above-mentioned (1), (2) or (3), wherein the iron-containing oxide present in the grain boundary surrounding the easily reducible metal oxide grains is any one of FeO, Fe₂O₃, Fe₃O₄, and a composite oxide between the easily reducible metal oxide(s) and Fe.

(5) An electric power generation cell precursor for a solid oxide fuel cell, the precursor comprising the fuel electrode precursor according to the above-mentioned (1), (2), (3) or (4).

The sintered body constituting the fuel electrode precursor of the present invention may have any density, but is further preferably a dense sintered body of 93% or more in density, the green body for the sintered body being constituted with the oxide ceramic grains and the easily reducible metal oxide grains. The reasons for this are as follows: when the precursor of an electric power generation cell and the electric power generation cell for a solid oxide fuel cell are fabricated by using the fuel electrode precursor, an electrolyte membrane and an air electrode membrane are needed to be formed on the surface of the fuel electrode precursor; when the density of the fuel electrode precursor is 93% or more, the number of pores becomes small and most of the pores becomes closed pores, and hence the polished surface of the surface-polished fuel electrode precursor is low in surface roughness to become flat and smooth, and the exposed pores are not communicatively connected so as to become crater-like concaves; consequently, when the electrolyte membrane and the air electrode membrane are formed by means of a physical vapor deposition method or a chemical vapor deposition method on such a fuel electrode precursor having a low-roughness and smooth surface, a uniform electrolyte membrane and a uniform air electrode membrane can be easily formed, and the precursor of an electric power generation cell and the electric power generation cell for a solid oxide fuel cell, both excellent in performances, can thereby be obtained. Additional reasons are that when the fuel electrode precursor is a dense sintered body of 93% or more indensity, the mechanical strength thereof becomes high, and when such a fuel electrode precursor is incorporated into a solid oxide fuel cell, the solid oxide fuel cell scarcely damaged during use or handling thereof.

The iron-containing oxide present in the grain boundary surrounding the easily reducible metal oxide grains attains an effect of decreasing the shrinkage rate even when the iron-containing oxide partially surrounds the easily reducible metal oxide grains; however, preferably the iron-containing oxide completely surrounds the easily reducible metal oxide grains, and further preferably the iron-containing oxide film completely surrounds the easily reducible metal oxide grains. The iron-containing oxide may be any one of FeO, Fe₂O₃, Fe₃O₄, and a composite oxide between the easily reducible metal oxide(s) and Fe. This is because these iron-containing oxides have only to be present as oxides in the process where the metal oxides such as NiO, CuO or RuO₂ are reduced.

Next, description will be made on a fabrication method of the fuel electrode precursor of low shrinkage rate in an electric power generation cell for a solid oxide fuel cell of the present invention.

As described above, the fuel electrode precursor in the electric power generation cell for a solid oxide fuel cell can be fabricated by sintering a mixed powder wherein the mixed powder is prepared by mixing a composite metal oxide powder prepared by forming an iron-containing oxide film on the surface of an easily reducible metal oxide powder with an oxide ceramic powder.

The composite metal oxide powder can be prepared as follows: the easily reducible metal oxide powder is soaked in an aqueous solution of iron citrate Fe(CH₄CO₂)₂ or an aqueous solution of iron nitrate Fe(NO₃)₂.6H₂O; the mixture thus obtained is heated in air for evaporation to dryness; the dried mixture is further heated at 300 to 800° C. for thermal decomposition to form an 1 to 10 nm thick iron-containing oxide layer on the surface of an oxide powder of any one of NiO, CuO and RuO₂, or an oxide powder of a mixture of two or three of NiO, CuO and RuO₂; and thus the composite oxide powder is prepared.

The fuel electrode precursor in the electric power generation cell for a solid oxide fuel cell, which fuel electrode precursor is made of the dense sintered body having a further preferable density of 93% or more in the present invention, is obtained by sintering the mixed powder prepared by mixing the composite metal oxide powder which is prepared by applying an iron-containing oxide film to the surface of the easily reducible metal oxide powder with the oxide ceramic powder in a volume ratio of 4/1 to 2/3. The particle size of the composite metal oxide powder is preferably set to be twice or more the particle size of the oxide ceramic powder. More specifically, the particle size of the oxide ceramic powder is appropriately selected from a range from 0.1 to 5 μm, and the particle size of the composite metal oxide powder is set to be twice or more the selected particle size of the oxide ceramic powder and is also appropriately selected from a range from 0.2 to 10 μm.

Thus, the present invention is characterized by the following aspects (6) to (9).

(6) A fabrication method of a fuel electrode precursor of low shrinkage rate in an electric power generation cell for a solid oxide fuel cell, comprising: preparing a mixed powder by mixing a composite metal oxide powder prepared by applying an iron-containing oxide film to the surface of an easily reducible metal oxide powder with an oxide ceramic powder; and sintering the thus obtained mixed powder.

(7) A fabrication method of a fuel electrode precursor of low shrinkage rate in an electric power generation cell for a solid oxide fuel cell, comprising: preparing a mixed powder by mixing a composite metal oxide powder prepared by applying an iron-containing oxide film to the surface of an easily reducible metal oxide powder with an oxide ceramic powder in a volume ratio of 4/1 to 2/3; and sintering the thus obtained mixed powder.

(8) The fabrication method of a fuel electrode precursor of low shrinkage rate in an electric power generation cell for a solid oxide fuel cell, according to the above-mentioned (6) or (7), wherein the iron-containing-oxide film formed on the surface of the easily reducible metal oxide powder constituting the composite metal oxide powder is a film of any one of FeO, Fe₂O₃, Fe₃O₄, and a composite oxide between the easily reducible metal oxide(s) and Fe.

(9) The fabrication method of a fuel electrode precursor of low shrinkage rate in an electric power generation cell for a solid oxide fuel cell, according to the above-mentioned (6), (7) or (8), comprising: soaking the easily reducible metal oxide powder in an aqueous solution of iron citrate or an aqueous solution of iron nitrate; heating the mixture thus obtained in air for evaporation to dryness; and further heating the dried mixture at 300 to 800° C. for thermal decomposition to prepare the composite oxide powder.

The electric power generation cell for a solid oxide fuel cell can be fabricated by using the fuel electrode precursor according to the above-mentioned (1), (2), (3) or (4), as follows: an electrolyte membrane is formed on the surface of the fuel electrode precursor according to the above-mentioned (1), (2), (3) or (4) by means of a physical vapor deposition method or a chemical vapor deposition method; an air electrode membrane is further formed on the surface of the electrolyte membrane by means of a brush-coating and baking method or the like; the laminate thus obtained is heated to 300 to 1000° C., and simultaneously the fuel electrode precursor is exposed in an atmosphere of a reductive gas such as hydrogen; and consequently the easily reducible metal oxide grains of the fuel electrode precursor is reduced to metal(s) to form the fuel electrode. Accordingly, the present invention is characterized by the following aspects (10) and (11).

(10) A fabrication method of an electric power generation cell for a solid oxide fuel cell, comprising: forming an electrolyte membrane on the surface of the fuel electrode precursor according to the above-mentioned (1), (2), (3) or (4); further forming an air electrode membrane on the surface of the electrolyte membrane; heating the laminate thus obtained to 300 to 1000° C., wherein simultaneously the fuel electrode precursor is exposed in an atmosphere of a reductive gas such as hydrogen; and consequently the easily reducible metal oxide grains of the fuel electrode precursor is reduced to metal(s) to form a fuel electrode.

(11) A solid oxide fuel cell, comprising the electric power generation cell for a solid oxide fuel cell, the electric power generation cell being fabricated by means of the method according to the above-mentioned (10).

The above-mentioned heating temperature falling within the range from 300 to 1000° C. means a temperature at which the fuel electrode precursor is converted into the fuel electrode; the temperatures of 300 to 1000° C. are known as the temperatures at which NiO, CuO and RuO₂ are reduced to Ni, Cu and Ru, respectively; accordingly, description is omitted on the reason for the constraint imposed on the heating temperature.

When the electric power generation cell for a solid oxide fuel cell is fabricated by using the fuel electrode precursor according to the above-mentioned (1), (2), (3) or (4), the easily reducible metal oxide constituting the fuel electrode precursor is reduced to metal(s) and thereby undergoes shrinkage. The shrinkage newly generates pores in such a way that the thus generated pores, without exception, abut the metal (namely, fuel electrode catalyst substance) generated by reduction; accordingly, the fuel gas diffuses to penetrate into the newly generated pores to be brought into contact with the fuel electrode catalyst substance; and consequently, the electrochemical reaction can be made to proceed further efficiently.

### Effects of the Invention

A solid oxide fuel cell incorporating the electric power generation cell precursor fabricated by using the fuel electrode precursor of the present invention scarcely undergoes the generation of the cracking and the thickness nonuniformalization of the electrolyte membrane because of the low shrinkage of the fuel electrode precursor even when heated in a reductive atmosphere, and thus the solid oxide fuel cell concerned can generate electric power without degrading the electric power generation efficiency over a long period of time.

### DETAILED DESCRIPTION OF THE PREFERRED EMBODIMENTS

As the raw material powders for oxide ceramic powders, the following powders were made ready, any of them being commercially available and having an average particle size of 0.8 μm.

YSZ powder (an yttria-stabilized zirconia powder having a component composition containing Y₂O₃: 8 mol % with the balance being composed of ZrO₂),

ScSZ powder (a scandia-stabilized zirconia powder having a component composition containing Sc₂O₃: 8 mol % with the balance being composed of ZrO₂),

SDC powder (a samarium-doped ceria powder having a composition of (Ce_{0.8}Sm_{0.2})O₂), and

GDC powder (a gadolinium-doped ceria powder having a composition of (Ce_{0.8}Gd_{0.2})O₂)).

Further, as the raw material powders for the easily reducible metal oxide powders, a NiO powder, a CuO powder and a RuO₂ powder were made ready, any of them being commercially available and having an average particle size of 2 μm.

Further, as the raw material powders for the composite metal oxide powders, an iron oxide-coated NiO powder, an iron oxide-coated CuO powder and an iron oxide-coated RuO₂ powder were made ready by preparing them as follows: each of the above-mentioned NiO, CuO and RuO₂ powders was soaked in an aqueous solution containing 10 mol % of iron citrate Fe (CH₄CO₂)₂; the mixture was heated to and maintained at 200° C. in an atmosphere of air to be evaporated, dried and solidified; and the dried mixture thus obtained was further heated at 400° C. for thermal decomposition to yield a NiO, CuO or RuO₂ powder the surface of which was coated with a thin iron oxide layer of 5 nm in average thickness; thus, the above-mentioned iron oxide-coated metal oxide powders were prepared.

### EXAMPLE 1

The raw material powders for the oxide ceramic powders, made ready as described above, namely, the YSZ powder, the ScSZ powder, the SDC powder and the GDC powder were mixed with the iron oxide-coated NiO powder, the iron oxide-coated CuO powder and the iron oxide-coated RuO₂ powder, in the proportions shown in Tables 1 to 8 to prepare mixed powders; the thus obtained mixed powders each were formed into a compact; the compacts thus prepared were fired in air, the firing temperatures being shown in Tables 1 to 8; thus the long and thin fuel electrode precursors 1 to 56 of the present invention each having the dimensions of 50 mm in length, 10 mm in width and 1 mm in thickness were fabricated. These fuel electrode precursors 1 to 56 of the present invention were maintained under the conditions of the same reductive atmosphere as that for the electric power generation conditions of the fuel electrode section in a solid oxide fuel cell, namely, the conditions:

temperature: 800° C.,

fuel gas: hydrogen, and

fuel gas flow rate: 0.2 L/min;

after an elapsed time of 1 hour, the dimensions of each of the fuel electrode precursors 1 to 56 of the present invention were measured; shrinkage rates were derived from the lengths measured before and after maintaining under the above-mentioned conditions of the fuel electrode precursors 1 to 56 of the present invention; and the results thus obtained are shown in Tables 1 to 8. It is to be noted that the shrinkage rates of the fuel electrode precursors 1 to 56 of the present invention were derived as follows: with L denoting the length of each of the fuel electrode precursors 1 to 56 of the present invention before maintaining under the above-mentioned conditions and with L′ denoting the length of each of the fuel electrode precursors 1 to 56 of the present invention after maintaining under the above-mentioned conditions, the shrinkage rate was derived from the formula: shrinkage rate=(L−L′)/L×100%.

### CONVENTIONAL EXAMPLE

The raw material powders for the oxide ceramic powders, made ready as described above, namely, the YSZ powder, the ScSZ powder, the SDC powder and the GDC powder were mixed with the raw material powders for the easily reducible-metal oxide powders, namely, the NiO powder, the CuO powder and the RuO₂ powder, in the proportions shown in Tables 1 to 8 to prepare mixed powders; the thus obtained mixed powders each were formed into a compact; the compacts thus prepared were fired in air, the firing temperatures being shown in Tables 1 to 8; thus the long and thin conventional fuel electrode precursors 1 to 56 each having the dimensions of 50 mm in length, 10 mm in width and 1 mm in thickness were fabricated. These conventional fuel electrode precursors 1 to 56 were maintained under the same conditions as in Example 1; after an elapsed time of 1 hour, the dimensions of each of the conventional fuel electrode precursors 1 to 56 were measured; shrinkage rates were derived from the lengths measured before and after maintaining under the above-mentioned conditions of the conventional fuel electrode precursors 1 to 56; and the results thus obtained are shown in Tables 1 to 8. It is to be noted that the shrinkage rates of the conventional fuel electrode precursors 1 to 56 were derived as follows: with L denoting the length of each of the conventional fuel electrode precursors 1 to 56 before maintaining under the above-mentioned conditions and with L′ denoting the length of each of the conventional-fuel electrode precursors 1 to 56 after maintaining under the above-mentioned conditions, the shrinkage rate was derived from the formula: shrinkage rate=(L−L′)/L×100%.
[Table 1]
[Table 2]
[Table 3]
[Table 4]
[Table 5]
[Table 6]
[Table 7]
[Table 8]

As can be seen from the results shown in Table 1, a comparison between the fuel electrode precursor 1 of the present invention and the conventional fuel electrode precursor 1 reveals that: the fuel electrode precursor 1 of the present invention and the conventional fuel electrode precursor 1 are the same in structure except the fact that the former precursor 1 has a structure in which iron oxide is present in the grain boundary, but the latter precursor 1 has a structure in which iron oxide is absent in the grain boundary; and the fuel electrode precursor 1 of the present invention having a structure in which iron oxide is present in the grain boundary is lower in shrinkage rate than the conventional fuel electrode precursor 1 having a structure in which iron oxide is absent in the grain boundary.

Similarly, as can be seen from the results shown in Tables 1 to 8, a comparison between the fuel electrode precursors 2 to 56 of the present invention and the conventional fuel electrode precursors 2 to 56, respectively, reveals that the fuel electrode precursors 2 to 56 of the present invention each having a structure in which iron oxide is present in the grain boundary are lower in shrinkage rate than the conventional fuel electrode precursors 2 to 56 each having a structure in which iron oxide is absent in the grain boundary.

As can be seen from the above comparisons, the electric power generation cells fabricated by using the fuel electrode precursors 1 to 56 of low shrinkage rate of the present invention, in particular, the fuel electrode-supported electric power generation cells, in each of which a thin electrolyte membrane is formed on the surface of a thick fuel electrode precursor having a high mechanical strength, each scarcely cause adverse effects such as the cracking and the thickness nonuniformalization of the electrolyte membrane due to the shrinkage of the fuel electrode precursor even for long term operation.

### EXAMPLE 2

The iron oxide-coated NiO powder and the SDC powder, both made ready in Example 1, were mixed together in proportions of the iron-coated NiO powder: 70% by volume and the SDC powder: 30% by volume; the mixed powder was press compacted by using a die under a pressure of 20 MPa to prepare a powder compact. The powder compact was fired in air under the conditions that the firing temperature was 1450° C. and the retention time was 5 hours, to fabricate a disc-like fuel electrode precursor of 17 mm in diameter, 1.5 mm in thickness and 98.5% in density. The one surface of the fuel electrode precursor was polished with a polishing paper, and then a dense, approximately 5 μm thick electrolyte membrane made of La_{0.9}Sr_{0.1}Ga_{0.8}Mg_{0.2}O₃ (LSGM) was formed over the whole polished surface of the fuel electrode precursor by means of the PLD (pulse laser deposition) method; further, a porous air electrode layer of 5 mm in diameter made of Sm_{0.5}Sr_{0.5}CoO₃ was formed on the surface of the formed electrolyte membrane by means of the brush-coating and baking method to fabricate an electric power generation cell precursor for a solid oxide fuel cell.

Next, an electric power generation cell for a solid oxide fuel cell was fabricated by reducing the easily reducible metal oxide, namely, NiO into metallic Ni by heating to 600° C. while a humidified hydrogen gas containing 3% H₂O was being flowed in the fuel electrode precursor section of the electric power generation cell precursor for a solid oxide-fuel cell at a flow rate of 100 ml/min. Simultaneously, oxygen gas was being flowed in the air electrode section at a flow rate of 100 ml/min. The shrinkage rate of the fuel electrode precursor due to the reduction was 0.6%, and no cracking was found in the electrolyte membrane. The porosity of the fuel electrode was 28%, and thus, there was obtained an open pore structure sufficiently allowing the combustion gas and the water vapor produced by electric power generation to enter thereinto and leave therefrom.

Next, an electric power generation test was carried out by using the thus obtained electric power generation cell for a solid oxide fuel cell. An electric power generation test was carried out at 700° C. while a humidified hydrogen gas containing 3% H₂O was being flowed in the fuel electrode section at a flow rate of 100 ml/min, and oxygen gas was being flowed in the air electrode section at a flow rate of 100 ml/min. Consequently, under the condition of the electric current density of 5000 mA/cm², there was obtained such a high performance that the voltage was 0.4 V and the electric power output density was 2000 mW/cm². After the electric power generation test, the cell was cooled down to room temperature, and neither cracking nor any sign of damage was found in the cell.

1. A fuel electrode precursor of low shrinkage rate in an electric power generation cell for a solid oxide fuel cell, the fuel electrode precursor being made of a sintered body prepared from a green body constituted with grains of an oxide ceramic (hereinafter referred to as oxide ceramic) composed of at least one of yttria-stabilized zirconia, scandia-stabilized zirconia, samarium-doped ceria and gadolinium-doped ceria and grains of a metal oxide (hereinafter referred to as easily reducible metal oxide) composed of at least one of nickel oxide, copper oxide and ruthenium oxide, wherein:
the fuel electrode precursor at least has a structure in which an iron-containing oxide is present in a grain boundary surrounding the easily reducible metal oxide grains.

2. A fuel electrode precursor of low shrinkage rate in an electric power generation cell for a solid oxide fuel cell, the fuel electrode precursor being made of a dense sintered body of 93% or more in density prepared from a green body constituted with grains of an oxide ceramic (hereinafter referred to as oxide ceramic) composed of at least one of yttria-stabilized zirconia, scandia-stabilized zirconia, samarium-doped ceria and gadolinium-doped ceria and grains of a metal oxide (hereinafter referred to as easily reducible metal oxide) composed of at least one of nickel oxide, copper oxide and ruthenium oxide, wherein:
the fuel electrode precursor at least has a structure in which an iron-containing oxide is present in the grain boundary surrounding the easily reducible metal oxide grains.

3. The fuel electrode precursor of low shrinkage rate in an electric power generation cell for a solid oxide fuel cell, according to claim 2, wherein the fuel electrode precursor made of the dense sintered body of 93% or more in density has a structure in which the easily reducible metal oxide grains and the oxide ceramic grains are dispersed in a volume ratio of 4/1 to 2/3 in the green body thereof.

4. The fuel electrode precursor of low shrinkage rate in an electric power generation cell for a solid oxide fuel cell, according to claim 1 or 2, wherein the iron-containing oxide present in the grain boundary surrounding the easily reducible metal oxide grains is any one of FeO, Fe₂O₃, Fe₃O₄, and a composite oxide between the easily reducible metal oxide(s) and Fe.

5. An electric power generation cell precursor for a solid oxide fuel cell, the electric power generation cell precursor comprising the fuel electrode precursor according to claim 1 or 2.

6. A fabrication method of a fuel electrode precursor of low shrinkage rate in an electric power generation cell for a solid oxide fuel cell, comprising:
preparing a mixed powder by mixing a composite oxide powder prepared by applying an iron-containing oxide film to the surface of a powder of a metal oxide (hereinafter referred to as easily reducible metal oxide) composed of at least one of nickel oxide, copper oxide and ruthenium oxide with a powder of an oxide ceramic (hereinafter referred to as oxide ceramic) composed of at least one of yttria-stabilized zirconia, scandia-stabilized zirconia, samarium-doped ceria and gadolinium-doped ceria;
forming the obtained mixed powder into a compact; and
sintering the obtained compact.

7. A fabrication method of a fuel electrode precursor of low shrinkage rate in an electric power generation cell for a solid oxide fuel cell, comprising:
preparing a mixed powder by mixing, in a volume ratio of 4/1 to 2/3, a composite oxide powder prepared by applying an iron-containing oxide film to the surface of a powder of a metal oxide (hereinafter referred to as easily reducible metal oxide) composed of at least one of nickel oxide, copper oxide and ruthenium oxide with a powder of an oxide ceramic (hereinafter referred to as oxide ceramic) composed of at least one of yttria-stabilized zirconia, scandia-stabilized zirconia, samarium-doped ceria and gadolinium-doped ceria;
forming the obtained mixed powder into a compact; and
sintering the obtained compact.

8. The fabrication method of a fuel electrode precursor of low shrinkage rate in an electric power generation cell for a solid oxide fuel cell, according to claim 6 or 7, wherein the iron-containing oxide film formed on the surface of the easily reducible metal oxide powder is a film of any one of FeO, Fe₂O₃, Fe₃O₄, and a composite oxide between the easily reducible metal oxide(s) and Fe.

9. The fabrication method of a fuel electrode precursor of low shrinkage rate in an electric power generation cell for a solid oxide fuel cell, according to claim 6 or 7, comprising:
soaking the easily reducible metal oxide powder in an aqueous solution of iron citrate or an aqueous solution of iron nitrate;
heating the mixture thus obtained in air for evaporation to dryness; and
further heating the dried mixture at 300 to 800° C. for thermal decomposition to prepare the composite oxide powder.

10. A fabrication method of an electric power generation cell for a solid oxide fuel cell, comprising:
forming an electrolyte membrane on the surface of the fuel electrode precursor according to claim 1 or 2;
further forming an air electrode membrane on the surface of the electrolyte membrane;
heating the laminate thus obtained to 300 to 1000° C., wherein simultaneously the fuel electrode precursor is exposed in an atmosphere of a reductive gas, and consequently the easily reducible metal oxide grains of the fuel electrode precursor is reduced to metal(s) to convert the fuel electrode precursor into a fuel electrode.

11. An electric power generation cell for a solid oxide fuel cell, the electric power generation cell comprising the electric power generation cell for a solid oxide fuel cell fabricated by means of the method according to claim 10.

12. A solid oxide fuel cell comprising the electric power generation cell for a solid oxide fuel cell fabricated by means of the method according to claim 11.
